(19) United States
(12) Patent Application Publication
(10) Pub. No.: US 2005/0254344 A1
(43) Pub. Date: Nov. 17, 2005

(54) Data transmission system and method using sound waves

(76) Inventor: David Barras, Schlieren (CH)

Correspondence Address: SUGHRUE MION, PLLC, 2100 PENNSYLVANIA AVENUE, N.W., SUITE 800, WASHINGTON, DC, 20037, US

(21) Appl. No.: 10/526,159

(22) PCT Filed: Dec. 24, 2002
(86) PCT No.: PCT/EP02/14900

§ 371 Date: Mar. 1, 2005

(30) Foreign Application Priority Data
Sep. 4, 2002 (EP) 02078628.1

(51) Int. Cl. H04B 11/00

(52) U.S. Cl. 367/76

(57) ABSTRACT

There is described a method of transmitting data by means of acoustic waves between a transmitter device (2) and a receiver device (1) wherein the transmitter device has a first electroacoustic transducer (26) for transmitting an acoustic carrier wave at one or more frequencies and means for modulating the acoustic carrier wave as a function of data to be transmitted and the receiver has a second electroacoustic transducer (18) for receiving the acoustic carrier wave modulated by the transmitter device and means for demodulating the acoustic carrier wave and extracting the transmitted data therefrom. The first and second electroacoustic transducers each have a determined bandwidth and a determined frequency response characteristic. The frequency of the acoustic carrier wave is varied during a determined time period to sweep a determined range of frequencies situated in the band common to the first and second electroacoustic transducers so that the frequency of the transmitted acoustic carrier wave does not coincide at any time with a peak or a trough of the frequency response characteristic of the first or the second electroacoustic transducer. There is also described a data transmission system for implementing the above method.

The present invention relates generally to systems and methods for transmitting data by means of acoustic waves.

In the context of the present description, the expression “acoustic wave” means an elastic wave producing a sound that is audible or inaudible depending on its wavelength or, in other words, an elastic wave whose wavelength in the propagation medium concerned corresponds to an infrasound or sound frequency or even an ultrasound frequency.

Systems employing acoustic waves to transmit data are known in the art. For example, U.S. Pat. No. 4,242,745 describes a timepiece provided with an electroacoustic transducer for receiving data transmitted by modulating an acoustic carrier wave generated by an external transmitter device.

U.S. Pat. No. 4,320,387 describes a portable device and a method for communicating data by means of acoustic waves. This document proposes in particular to transmit data by ultrasound using an electroacoustic transducer. It proposes in particular to transmit data using a technique of frequency modulation of the acoustic carrier wave known as frequency shift keying (FSK).

U.S. Pat. No. 5,719,825 and U.S. Pat. No. 5,848,027 both describe a system for recording and processing personal data of a user (for example the physical activity of an athlete) including in particular a data processing terminal and an electronic timepiece able to communicate by means of acoustic waves. More particularly, the timepiece is provided with an electroacoustic transducer (piezoelectric element) for transmitting personal data of the user to the data processing terminal, which is itself provided with a microphone for receiving acoustic waves generated by the timepiece.

The document EP 1 075 098, in the name of the present Applicant, describes an acoustic signal converter circuit and a method of bidirectional communication by means of acoustic waves for exchanging data between two timepieces or between a data processing terminal and a timepiece.

Finally, the document WO 2001/10064, also in the name of the present Applicant, describes a system for acoustic communication between a portable unit and a communication terminal.

The last two documents mentioned above propose in particular to use the existing audio installation (loudspeakers and sound card) of a data processing terminal to transmit the required data to a portable unit by means of acoustic waves. One advantage of this solution is that it is not necessary to provide the data processing terminal with any kind of device dedicated exclusively to transmitting and/or receiving data.

The typical solution envisaged until now for transmitting data acoustically, in particular from a data processing terminal to a portable unit, consists in generating an acoustic carrier wave at a determined frequency and modulating that acoustic carrier wave as a function of the data to be transmitted. The modulation of the acoustic carrier wave as a function of the data can, for example, consist in amplitude modulation, frequency modulation or phase modulation of the acoustic carrier wave using modulation techniques known in the art.

However, it is noticeable that the loudspeakers with which off the shelf data processing terminals are typically equipped are low cost devices and therefore have highly irregular frequency response characteristics. Measurements carried out on a sample of loudspeakers available off the shelf have shown strong variations in the amplitude of the signal as a function of frequency (often of greater than ±10 dB). In fact, most loudspeaker systems usually proposed for use with personal computers are not intended to reproduce high fidelity sound and their response curve is therefore very irregular. This irregular response curve is essentially due to the fact that the acoustic impedance of the speaker varies rapidly with frequency and has very marked extrema at its natural frequencies, leading to peaks and troughs in the response curve of the system. It is also noticeable that the amplitude distortion problem is aggravated if the distance between the loudspeaker and the portable unit is short.

A drawback associated with using existing loudspeaker systems is therefore that it is not possible to assure highly reliable transmission of data by means of acoustic waves as the frequency of the acoustic carrier wave may coincide with a peak or a trough in the frequency response of the loudspeaker, regardless of the modulation technique used to transmit the data.

A solution must therefore be found which allows increasing the reliability of the transmission of such a data transmission system using acoustic waves. The object of the present invention is to propose one such solution.

To this end, the present invention proposes a method with the features set out in claim 1 for transmitting data by means of acoustic waves between a sender transmitter device and a receiver device.

The present invention also consists in a system with the features set out in claim 9 for transmitting data by means of acoustic waves for implementing the above transmission method.

Advantageous embodiments of the present invention form the subject matter of dependent claims.

Thus, according to the invention, the frequency of the acoustic carrier wave is varied, during a determined time period, to sweep a determined range of frequencies in the band common to the first and second electroacoustic transducers respectively equipping the transmitter and receiver devices. This assures that the frequency of the transmitted acoustic carrier wave does not at any time coincide with a peak or a trough of the frequency response characteristic of the first or second electroacoustic transducer.

Data is transmitted by appropriate modulation (in particular amplitude modulation) of the acoustic carrier wave, complemented by frequency modulation of the acoustic carrier wave with the essential object of widening the send frequency spectrum of the acoustic signal in the bandwidth of the transmitter and/or receiver device. Varying the frequency of the acoustic carrier wave in this manner ensures that the frequency of the transmitted signal does not at any time coincide with a peak or a trough in the frequency response of the acoustic system which is employed. It is therefore clear that, according to the invention, two modulations of the acoustic carrier wave are superposed, one to transmit data and the other, in this instance involving variation or modulation of the frequency of the acoustic carrier wave, to ensure sufficient spectral diversity of the acoustic carrier wave.

In one particularly advantageous embodiment of the present invention that has proved particularly effective, the frequency of the acoustic carrier wave generated by the acoustic transducer of the transmitter device is varied by a frequency modulation technique using one or more modulating signals. It has been found that using this solution leads to very high reliability of data transmission.

In one embodiment of the data transmission system, there is also provision for storing the acoustic carrier wave in the form of a succession of samples stored in a table. This greatly simplifies the generation of the modulated acoustic carrier wave in that it is sufficient to consult the table and to generate the acoustic carrier wave on the basis of the succession of stored samples. It is therefore not necessary to provide the transmitting system with dedicated electronic means. In fact it is sufficient to provide a simple data processing application known as a “plug-in” to implement the invention on a data processing terminal.

Generally speaking, it is clear that two methods may be used to generate the acoustic carrier wave: either direct generation according to which the acoustic carrier wave is generated by means of a mathematical function implemented when sending the data, or indirect generation according to which a predefined “wave table” is stored and may be read at the time of resituating the acoustic carrier wave.

It will be noted that a further advantage of the present invention is that implementing the invention necessitates no modification of the receiver unit, which operates in a manner that is in every respect analogous to what was the situation previously. Implementation of the invention is therefore particularly simple and inexpensive.

Other features and advantages of the present invention will become more clearly apparent on reading the following detailed description of embodiments of the invention, which is given by way of non-limiting example only and illustrated by the appended drawings, in which:

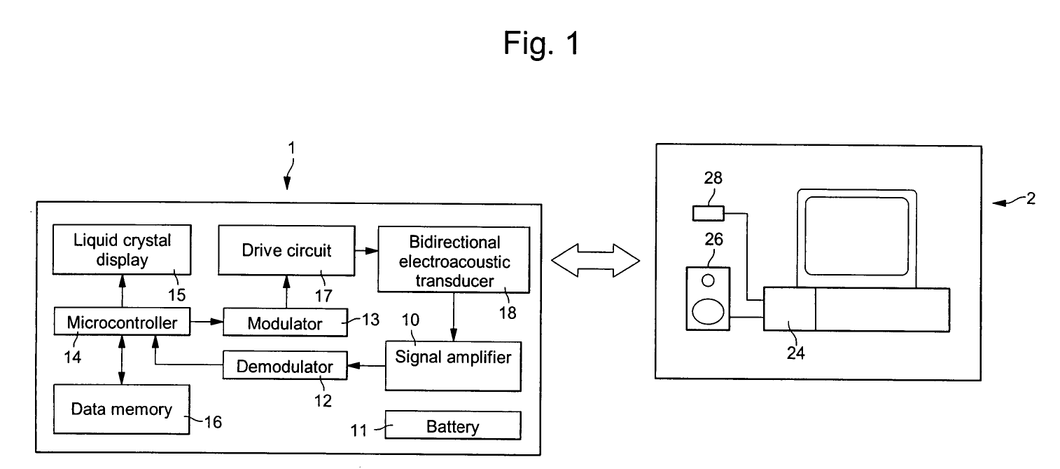

FIG. 1 is a diagram of a system for communicating data by means of acoustic waves between a data processing terminal and a portable unit such as a watch;

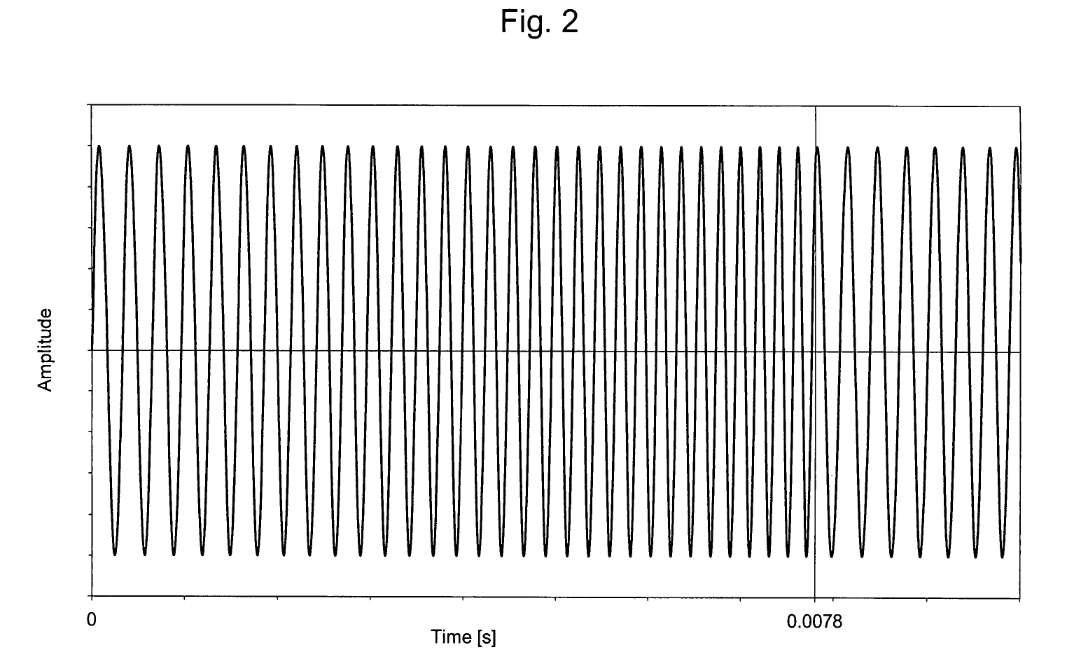

FIG. 2 is a timing diagram of an acoustic carrier wave generated according to a first implementation mode of the invention in which the frequency of the acoustic carrier wave is varied in substantially linear fashion over a determined range of frequencies;

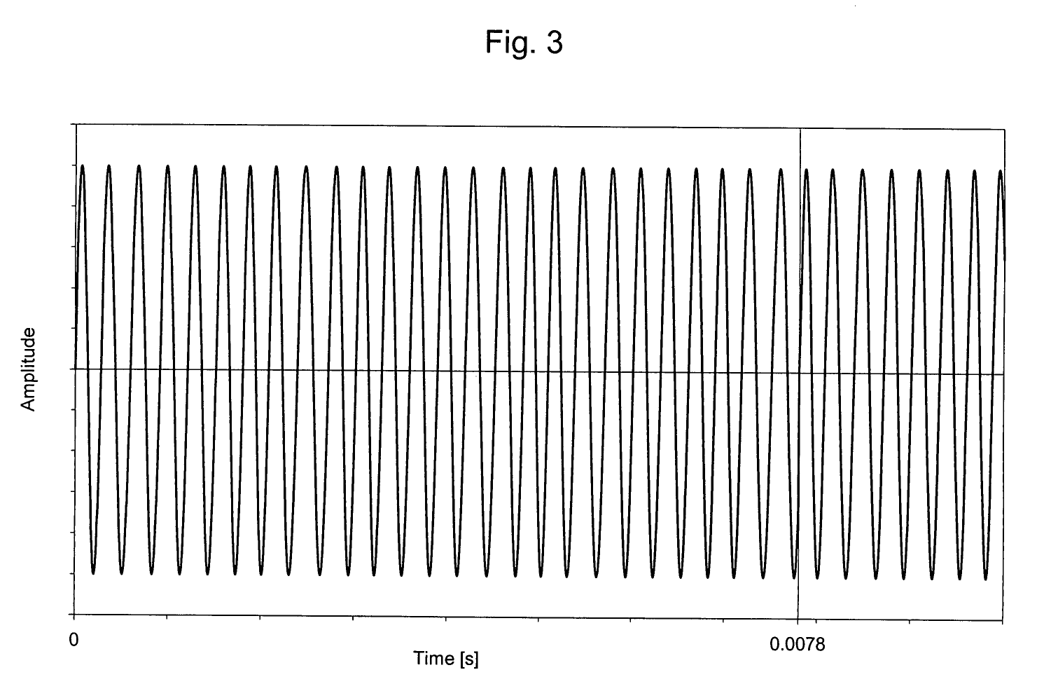

FIG. 3 is a timing diagram of an acoustic carrier wave generated according to another implementation mode of the invention in which the frequency of the acoustic carrier wave is varied by means of frequency modulation technique employing two modulating signals;

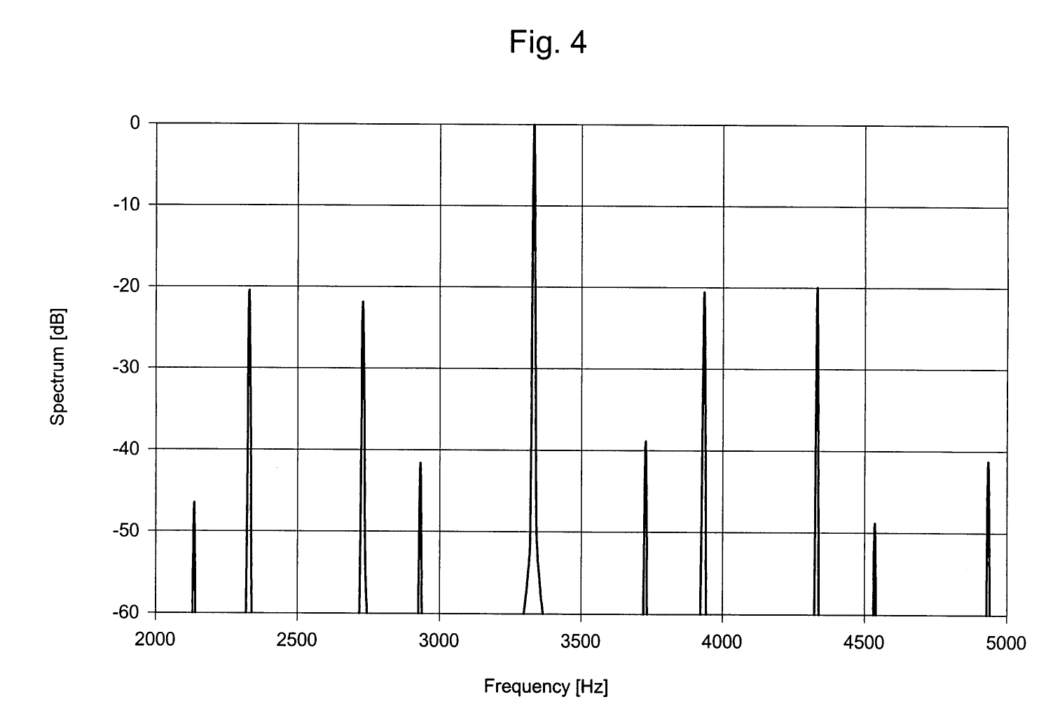

FIG. 4 is a diagram of the frequency spectrum resulting from continuous sending of the acoustic carrier wave according to the implementation mode of FIG. 3;

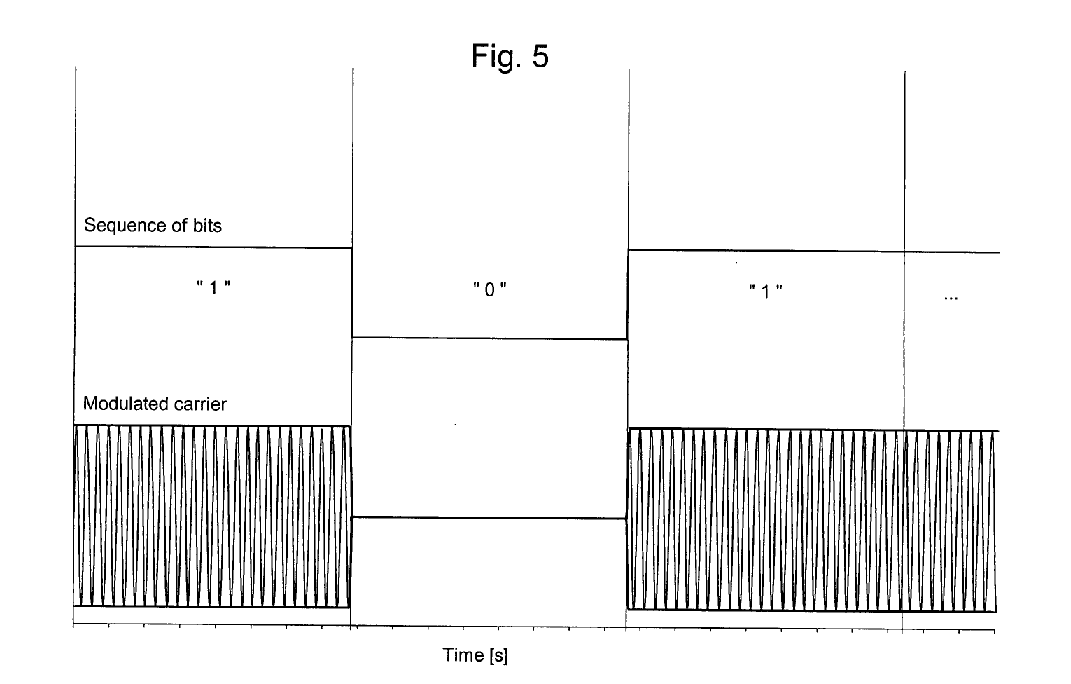

FIG. 5 is a diagram of the transmission of a determined sequence of bits by amplitude modulating of the acoustic carrier wave frequency-modulated according to the implementation mode of FIG. 3; and

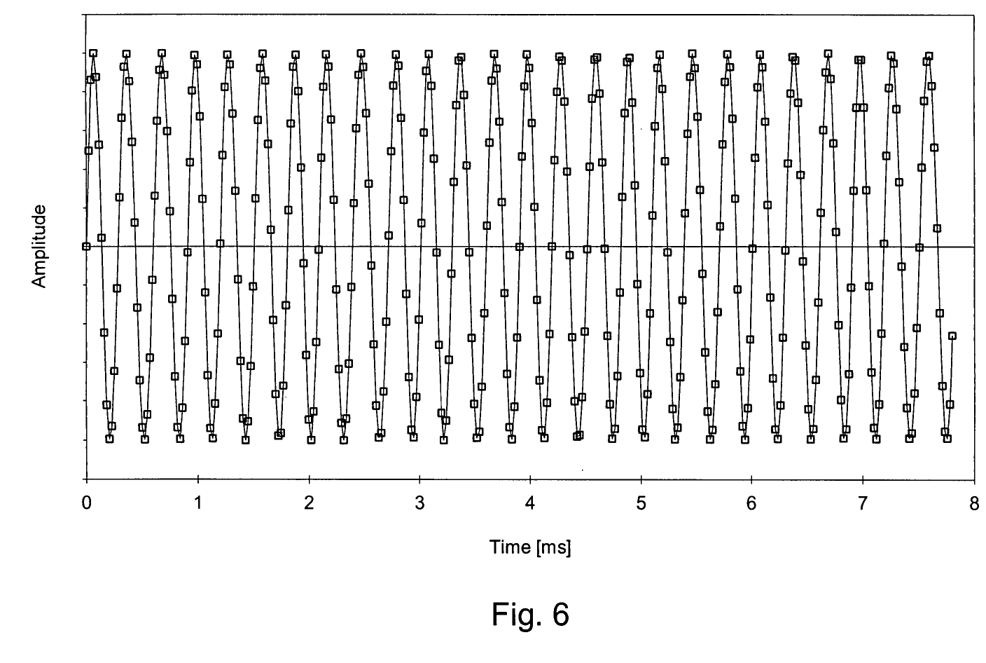

FIG. 6 is a diagram of a succession of samples defining the FIG. 3 acoustic carrier wave over the time taken to send one bit.

FIG. 1 is a diagram of a system for communicating data by means of acoustic waves between a data processing terminal and a portable unit designated as a whole by the numeral references 1 and 2 respectively. The portable unit 1 may advantageously take the form of a wristwatch that may be worn on the wrist of a user, for example.

The data processing terminal 2 may be an off the shelf personal computer (PC) comprising means for emitting acoustic signals conveying information. In the schematic example depicted in FIG. 1, these means typically take the form of a sound card 24 disposed inside the personal computer, one or more loudspeakers 26 and a microphone 28.

It will be remembered that one advantage of the system shown in FIG. 1 is that it is not necessary to modify the structure of the data processing terminal or to add to it transmitting components specific to the type of wireless link used. To implement the invention, it is sufficient to load into the computer a program enabling it to modulate the acoustic signal so that this signal may afterwards be decoded correctly by the portable unit 1.

If the data processing terminal 2 sends an acoustic signal conveying information by means of its loudspeaker(s) 26, the signal is immediately picked up by the receiver means of the portable unit 1. These receiver means take the form of a bidirectional electroacoustic transducer 18 which serves at the same time as a microphone (acoustic receiver) and a loudspeaker (acoustic transmitter). In receive mode, this electroacoustic transducer 18 transforms the incoming acoustic signal into an electrical signal which is then converted by converter means of the portable unit 1 into data to be processed by processing means of this unit in order to extract therefrom useful information carried by the acoustic signal. In the FIG. 1 example, the conversion means of the portable unit 1 comprise an amplifier 10 for amplifying the electrical signal produced by the electroacoustic transducer 18 and a demodulation circuit (demodulator) 12 connected to the signal amplifier and adapted to demodulate the received signal and to pass the demodulated signal to an input of a microcontroller 14 constituting the processing means of the portable unit. The information carried by the acoustic signal sent by the data processing terminal 2, demodulated by the demodulator 12 and processed by the microcontroller 14, may be stored in a memory 16 of the portable unit 1 and/or displayed on a display device 15, for example a liquid crystal display. A battery 11, which may be a rechargeable battery, supplies the portable unit 1 with electrical power.

In the context of sending data by acoustic way using the portable unit, this latter unit is further equipped with conversion and sending means for converting data supplied by the processing means of the portable unit into a modulated acoustic signal and sending that signal. As shown in FIG. 1, these conversion means comprise a modulation circuit (modulator) 13 which drives the transmitter means, namely the electroacoustic transducer 18, via a driver circuit 17. The processing means of the portable unit 1, i.e. the microcontroller 14, control the modulation circuit 13 as a function of the data to be transmitted, which is typically stored in the memory 16 of the portable unit 1.

It will further be noted that the microcontroller 14 in FIG. 1 typically comprises encoding and decoding means (respectively upstream and downstream of the modulator 13 and the demodulator 12). Also, the modulator 13 and/or the demodulator 12 may in practice constitute an integral part of the functions of the microcontroller 14.

The detailed structure of the electroacoustic transducer and the associated processing and conversion means are not described in detail here. See, for example, the documents EP 1 075 098 and WO 2001/10064 cited in the preamble and incorporated herein by reference. Those documents propose in particular modifying a sound generator circuit used conventionally to generate alarms into a bidirectional converter circuit able to convert a modulated acoustic signal into an electrical signal and vice-versa.

It should be noted that the communication system shown in FIG. 1 is adapted to provide bidirectional communication between the data processing terminal and the portable unit, the loudspeaker(s) 26 being used to transmit data from the personal computer 2 to the portable unit 1 and the microphone 28 being used to receive data transmitted by the portable unit 1. The remainder of the description is more particularly concerned with transferring data from the data processing terminal 2 to the portable unit 1.

As mentioned in the preamble, one drawback of the prior art solutions is that the frequency of the acoustic carrier wave used to transmit data may coincide with a trough or a peak of the frequency response of the loudspeaker. This problem arises regardless of the type of modulation used to code the information. In the case of amplitude modulation, the information is coded by varying the amplitude of the acoustic carrier wave, which is transmitted at a determined frequency that may thus coincide with an irregularity in the frequency response of the loudspeaker. The same applies to phase modulation, where information is coded by varying the phase of the signal. Finally, in the case of frequency modulation, in which information is coded by varying the frequency of the acoustic carrier wave, the frequency of the modulated acoustic carrier wave can at least partly coincide with an irregularity in the frequency response of the loudspeaker, and a portion of the data may consequently be lost.

According to the invention, the choice is nevertheless made to introduce high spectral diversity into the acoustic carrier wave by varying the frequency of the carrier wave in a range of determined frequencies in the bandwidth common to the electroacoustic transducer of the loudspeaker and the electroacoustic transducer of the portable unit. The data to be transmitted are transmitted by appropriate modulation of the acoustic carrier wave that is itself frequency-modulated. The choice of the modulation used to transmit the data is dictated by the condition that there must be no or little interference between the two modulations (the modulation used to transmit the data and the frequency modulation adopted to ensure sufficient spectral diversity of the acoustic carrier wave).

The simplest solution is to use amplitude modulation of the acoustic carrier wave to transmit the data in addition to frequency modulation of this acoustic carrier wave. In this case, it will be noted that it is nevertheless necessary to choose frequency modulation parameters ensuring, firstly, as already mentioned, sufficient spectral diversity of the acoustic carrier waves and, secondly, that the envelope of the acoustic signal is affected as little as possible.

An alternative to amplitude modulation might be frequency modulation. It will be noted that in this case decoding the information becomes more complex because the frequency modulation used to transmit the data is superposed on the frequency modulation used to spread the frequency spectrum in the useful bandwidth. In this case, an I/Q demodulator (with signals in phase quadrature) could allow to discriminate the phase or the frequency of the carrier wave.

In the remainder of the description, it will be assumed for the sake of simplicity that the data is transmitted by amplitude modulation of the acoustic carrier wave. To be more specific, the basic principle is that the acoustic carrier wave has a determined non-zero amplitude level over the bit sending time when the bit value is equivalent to a first logic level (for example “1”) and a zero amplitude level over the bit sending time when the bit value is equivalent to the second logic level (for example “0”). For example, one can refer to FIG. 5 which shows a diagram of sending a sequence of bits using the abovementioned technique.

Note that here there is a specific amplitude modulation mode and that other amplitude modulation modes may perfectly well be envisaged, for example a modulation mode in which a bit at “1” is transmitted in the form of a succession of two half-periods in which the amplitude of the acoustic carrier wave is first non-zero and then zero and conversely in which a bit at “0” is transmitted in the form of a succession of two half-periods in which the amplitude of the acoustic carrier wave is first zero and then non-zero (this is commonly referred to as Manchester modulation or coding).

The solution for achieving great spectral diversity of the acoustic signal in a determined range of frequencies consists in varying the frequency of the acoustic carrier wave in the useful bandwidth, i.e. the bandwidth common to the electroacoustic transducer of the loudspeaker and the electroacoustic transducer of the portable unit. By way of purely illustrative and non-limiting example, it has been determined that the useful bandwidth of the system could correspond to a range of frequencies from approximately 2700 Hz to approximately 4000-4500 Hz, (i.e. a bandwidth of the order of 1.5 kHz), this bandwidth being essentially determined by the characteristics of the electroacoustic transducer employed in the portable unit and by the construction of the portable unit.

A first solution that may be envisaged consists in varying the frequency in the useful band in a substantially linear manner. In this case, the acoustic carrier wave may be expressed in the following analytical form:
CARRIER(t)=sin(2π(f0+Δf·(t/Tbit))·t+alpha) (1)
in which f0 is the starting frequency of the frequency sweep, Δf corresponds to half of the frequency band to be swept, Tbit is the bit sending time, and alpha is an appropriate phase-shift for ensuring the continuity of the acoustic carrier wave from one bit to another (this phase-shift may be neglected if appropriate). This phase-shift alpha may be expressed in the following manner:
alpha=(2π·(f0+Δf)·Tbit)·(N−1) (2)
in which N corresponds to the N^{th} bit concerned.

FIG. 2 represents the acoustic carrier wave conforming to the above equation (1). In this figure, an arbitrary bit sending time of approximately 7.8 ms (to be exact: 1/128=7.8125 ms) and values for the parameters f0 and Δf of 3000 Hz and 1000 Hz, respectively, have been chosen. Note that in this figure the phase alpha of the signal is also adjusted from one bit to the next.

Spectral analysis of the acoustic carrier wave generated in accordance with the above principle shows that the range of frequencies over which the acoustic carrier wave is generated essentially extends from the selected frequency f0 over a bandwidth equivalent to 2×Δf. In the above numerical example, where the values of f0 and Δf are respectively 3000 Hz and 1000 Hz, the spectrum of the generated acoustic carrier wave lies essentially in a band of frequencies from 3000 Hz to 5000 Hz.

Δn alternative solution to the solution consisting in varying the frequency of the acoustic carrier wave in a linear manner over a determined frequency range consists in varying the frequency of the acoustic carrier wave by frequency modulation technique using one or more modulating signals. In the case of frequency modulation using two modulating signals, the acoustic carrier wave may be expressed in the following analytical form:
CARRIER(t)=sin(2π·f0·t+Δ1/f1 sin(2π·f1·t)+Δ2/f2 sin(2π·f2·t)) (3)
in which f0 is the centre frequency of the acoustic carrier wave, f1 and Δ1 are respectively the frequency and the maximum deviation of the first modulating signal and f2 and Δ2 are respectively the frequency and the maximum deviation of the second modulating signal. As previously mentioned with reference to equation (1), although this parameter is not necessary, it may be further envisaged that the definition of the acoustic carrier wave referred to above includes a phase shift selected to ensure continuity of the acoustic carrier wave from one bit to another.

FIG. 3 shows the acoustic carrier wave conforming to the above equation (3). In this figure, the bit sending time Tbit is again equivalent to approximately 7.8 ms. Respective values of the parameters f0, f1, Δ1, f2 and Δ2 in this example are 3331 Hz, 1000 Hz, 200 Hz, 600 Hz and 120 Hz. Note that the choice of the parameters f0, f1, Δ1, f2 and Δ2 is dictated by certain constraints. Thus the centre frequency f0 is defined as a function of the useful bandwidth of the system and is substantially in the middle of that useful bandwidth. The modulation parameters f1, Δ1, f2 and Δ2 are chosen as a function of the bit sending time Tbit and the useful bandwidth of the system, the essential constraint being to ensure sufficient spectral diversity of the acoustic carrier wave in the useful bandwidth.

The parameters f0, f1, f2, Δ1 and Δ2 selected vary the bandwidth of the frequency spectrum of the acoustic carrier wave and the number and the positions of the frequency peaks of the acoustic carrier wave. FIG. 4 shows by way of illustrative example the spectrum resulting from continuous repetition of the FIG. 3 acoustic carrier wave when the repetition period is 7.8 ms. Note in particular a frequency peak at the centre frequency of 3331 Hz and additional peaks at 2331 Hz, 2731 Hz, 3931 Hz and 4331 Hz, as well as other frequency peaks of lower intensity.

From a qualitative point of view, it is found that the second solution referred to above, in which the acoustic carrier wave is modulated by one or more modulating signals, gives better results. Note that, as the data is transmitted by amplitude modulation of the acoustic carrier wave, the modulation of the frequency of the acoustic carrier wave which is adopted must be such that the envelope of this acoustic carrier wave remains substantially constant (i.e. remains substantially unaffected) for a given amplitude modulation level, so as not to interfere much or at all with the transmission of data.

In the context of implementing the invention on a data processing terminal equipped with one or more loudspeakers, it will be advantageous (in particular in relation to limiting the computation load of the data processing terminal), to store the acoustic carrier wave in the form of a succession of predetermined samples. In particular, a succession of samples representative of the acoustic carrier wave over the duration of a bit must be memorised, for example in the form of a table stored in the memory of the data processing terminal. To generate the acoustic wave, it is then sufficient to consult the stored table to generate the portion of the acoustic carrier wave corresponding to the bit sending time and to repeat that operation for each bit to be transmitted. This acoustic carrier wave is then modulated as a function of the data to be transmitted. In the particular situation where the data is transmitted by amplitude modulation in accordance with the principle referred to above in relation to FIG. 5, it is clear that, properly speaking, the acoustic carrier wave is generated only when it is necessary to transmit a bit at “1”, the acoustic carrier wave having a zero amplitude when a bit at “0” is transmitted.

It will be appreciated that a sampling frequency of 44.1 kHz is typically adopted for sampling audio signals on personal computers. For a bit sending time Tbit of approximately 7.8 ms, for example, the acoustic carrier wave can therefore be represented by a set of 344 successive samples. FIG. 6 represents the FIG. 3 acoustic carrier wave sampled at 44.1 kHz over one bit sending time.

It is generally clear that various modifications and/or improvements that will be evident to the person skilled in the art may be made to the embodiments described herein without departing from the scope of the invention as defined by the appended claims. In particular, the present invention is not limited to the two implementing modes described above, in which the frequency of the acoustic carrier wave is varied in a substantially linear manner or by a frequency modulation technique employing a plurality of modulating signals. Any other appropriate form of modulation may be adopted to vary the frequency of the acoustic carrier wave provided that this modulation ensures sufficient spectral diversity of the acoustic carrier wave in the required bandwidth.

Finally, the present invention is not limited to the implementation of the proposed method in a system including at least a data processing terminal and a portable unit. The proposed transmission method applies to any system for transmitting data by means of acoustic waves in which the electroacoustic transducer of the transmitter device has an irregular frequency response. Similarly, the same principle may be adopted to prevent the frequency of the acoustic carrier wave coinciding with an irregularity in the frequency response of the electroacoustic transducer used in the receiver (for example the microphone of the data processing terminal). The proposed transmission method could therefore be implemented in the portable unit to improve the reliability of data transmission from the portable unit to the data processing terminal.

Moreover, the configuration of the portable unit shown in FIG. 1 employs a bidirectional electroacoustic transducer. It is clear that two electroacoustic transducers respectively dedicated to sending and receiving data could be used. Finally, the present invention also applies to a unidirectional data transmission system.

1-10. (canceled)

11. A method of transmitting data by means of acoustic waves between a transmitter device and a receiver device,
said transmitter device having a first electroacoustic transducer for transmitting an acoustic carrier wave at at least one frequency and means for modulating said acoustic carrier wave as a function of data to be transmitted,
said receiver device having a second electroacoustic transducer for receiving said acoustic carrier wave modulated by the transmitter device and means for demodulating said acoustic carrier wave and extracting the transmitted data therefrom, and
said first and second electroacoustic transducers each having a determined bandwidth and a determined frequency response characteristic,
wherein the frequency of said acoustic carrier wave is varied during a determined time period to sweep a determined range of frequencies situated in the bandwidth common to said first and second electroacoustic transducers so that the frequency of the transmitted acoustic carrier wave does not coincide at any time with a peak or a trough of the frequency response characteristic of said first or said second electroacoustic transducer.

12. The method according to claim 11, wherein said modulation means of the transmitter device are amplitude modulation means and in that the frequency of said acoustic carrier wave is varied so that the envelope of this acoustic carrier wave remains substantially constant for a given modulation amplitude level.

13. The method according to claim 11, wherein the frequency of said acoustic carrier wave is varied in a substantially linear manner over said determined range of frequencies.

14. The method according to claim 12, wherein the frequency of said acoustic carrier wave is varied in a substantially linear manner over said determined range of frequencies.

15. The method according to claim 11, wherein the frequency of said acoustic carrier wave is varied by means of a frequency modulation technique employing one or more modulating signals.

16. The method according to claim 12, wherein the frequency of said acoustic carrier wave is varied by means of a frequency modulation technique employing one or more modulating signals.

17. The method according to claim 15, wherein the frequency of said acoustic carrier wave is varied by means of a frequency modulation technique employing two modulating signals and has the shape of the type defined by the following equation:
CARRIER(t)=sin(2π·f₀·t+Δ1/f1 sin(2π·f1·t)+Δ2/f2 sin(2π·f2·t)) (3)
in which CARRIER(t) is the expression for said acoustic carrier wave as a function of time, f0 is the centre frequency of said acoustic carrier wave, f1 and Δ1 are respectively the frequency and the maximum deviation of the first modulating signal and f2 and Δ2 are respectively the frequency and the maximum deviation of the second modulating signal.

18. The method according to claim 16, wherein the frequency of said acoustic carrier wave is varied by means of a frequency modulation technique employing two modulating signals and has the shape of the type defined by the following equation:
CARRIER(t)=sin(2πf₀·t+Δ1/f1 sin(2π·f1·t)+Δ2/f2 sin(2π·f2·t)) (3)
in which CARRIER(t) is the expression for said acoustic carrier wave as a function of time, f0 is the centre frequency of said acoustic carrier wave, f1 and Δ1 are respectively the frequency and the maximum deviation of the first modulating signal and f2 and Δ2 are respectively the frequency and the maximum deviation of the second modulating signal.

19. The method according to claim 15, wherein said acoustic carrier wave is an acoustic wave that has a centre frequency of the order of 3000 Hz to 3500 Hz which is frequency modulated by said modulating signals.

20. The method according to claim 16, wherein said acoustic carrier wave is an acoustic wave that has a centre frequency of the order of 3000 Hz to 3500 Hz which is frequency modulated by said modulating signals.

21. The method according to claim 17, wherein said acoustic carrier wave is an acoustic wave that has a centre frequency of the order of 3000 Hz to 3500 Hz which is frequency modulated by said modulating signals.

22. The method according to claim 18, wherein said acoustic carrier wave is an acoustic wave that has a centre frequency of the order of 3000 Hz to 3500 Hz which is frequency modulated by said modulating signals.

23. The method according to claim 15, wherein the data to be transmitted comprises a succession of bits transmitted by amplitude modulation of said acoustic carrier wave between first and second determined amplitude levels and wherein the parameters of frequency modulation of said acoustic carrier wave are selected so that the frequency spectrum of the acoustic carrier wave resulting from said frequency modulation covers substantially all of the band common to the transmitter and receiver devices.

24. The method according to claim 16, wherein the data to be transmitted comprises a succession of bits transmitted by amplitude modulation of said acoustic carrier wave between first and second determined amplitude levels and wherein the parameters of frequency modulation of said acoustic carrier wave are selected so that the frequency spectrum of the acoustic carrier wave resulting from said frequency modulation covers substantially all of the band common to the transmitter and receiver devices.

25. The method according to claim 11, wherein said acoustic carrier wave is stored in said transmitter device in the form of a succession of samples stored in a table.

26. A system for transmitting data by means of acoustic waves for implementing the transmission method according to claim 11, wherein this system comprises:
a data processing terminal associated with at least one acoustic transmitter device having a first electroacoustic transducer for transmitting said acoustic carrier wave, and
at least a portable device provided with an acoustic receiver device having a second electroacoustic transducer for receiving said acoustic carrier wave.

27. The system for transmitting data according to claim 26, wherein said acoustic carrier wave is stored in said data processing terminal in the form of a succession of samples stored in a table and wherein said data processing terminal comprises software means for:
consulting said table,
generating an acoustic carrier wave based on said succession of samples, and
modulating the acoustic carrier wave as a function of the data to be transmitted.
